(19) United States
(12) Patent Application Publication
(10) Pub. No.: US 2026/0219855 A1
(43) Pub. Date: Jul. 30, 2026

(54) VERSIONING AND DEPLOYMENT OF ARTIFICIAL INTELLIGENCE MODELS AND RUNTIME ASSETS IN A SHARED ENVIRONMENT

(71) Applicant: DELL PRODUCTS L.P., Round Rock, TX (US)

(72) Inventors: Jacob Mink, Cedar Park, TX (US); Spencer Bull, Conroe, TX (US); Tyler Cox, Austin, TX (US); Nicholas Wanner, Austin, TX (US)

(21) Appl. No.: 19/037,012

(22) Filed: Jan. 24, 2025

(51) Int. Cl. G06F 8/61

(52) U.S. Cl. CPC G06F 8/61

(57) ABSTRACT

An information handling system launches an installer of a software package at an information handling system and the software package includes an artificial intelligence model plugin and a dependency. The information handling system also determines whether the artificial intelligence model plugin can be executed on the information handling system. In addition, the information handling system installs the artificial intelligence model plugin in response to a determination that the artificial intelligence model plugin can be executed on the information handling system. Further, the information handling system loads the artificial intelligence model plugin and the dependency in an isolated load environment of a model management framework at runtime.

### FIELD OF THE DISCLOSURE

The present disclosure generally relates to information handling systems, and more particularly relates to versioning and deployment of artificial intelligence models and runtime assets in a shared environment.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may launch an installer of a software package in an information handling system, and the software package may include an artificial intelligence model plugin and a dependency. The information handling system may determine whether the artificial intelligence model plugin can be executed on the information handling system. In addition, the information handling system may install the artificial intelligence model plugin in response to a determination that the artificial intelligence model plugin can be executed on the information handling system. Further, the information handling system may load the artificial intelligence model plugin and the dependency in an isolated load environment of a model management framework at runtime.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system configured for consumption of language model contracts by an artificial intelligence application, according to an embodiment of the present disclosure;

FIG. 2 is a block diagram of an information handling system for versioning and deployment of artificial intelligence models and runtime assets in a shared environment, according to an embodiment of the present disclosure;

FIG. 3 is a flowchart of a method for installing model management framework core components, according to an embodiment of the present disclosure;

FIG. 4 is a flowchart of a method for versioning and deployment of artificial intelligence models and runtime provider assets in a shared environment, according to an embodiment of the present disclosure;

FIG. 5 is a flowchart of a method for installing runtime provider assets, according to an embodiment of the present disclosure;

FIG. 6 is a flowchart of a method for installing artificial intelligence models, according to an embodiment of the present disclosure; and

FIG. 7 is a block diagram illustrating an information handling system, according to an embodiment of the present disclosure;

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

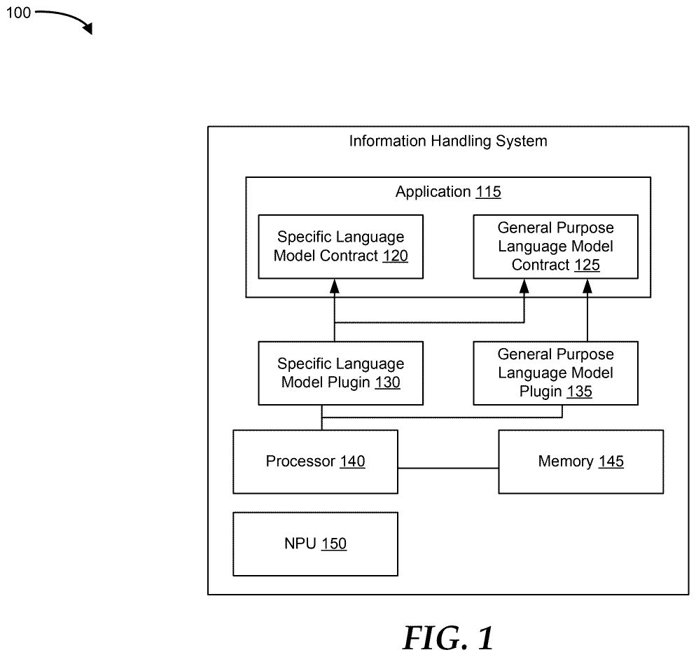

FIG. 1 illustrates a portion of an information handling system 100 configured for consumption of language model contracts by an artificial intelligence (AI) application, according to an embodiment of the present disclosure. Information handling system 100 includes an application 115, specific language model plugin 130 and general purpose language model plugin 135, a processor 140, a memory 145, and a neural processing unit (NPU) 150. Processor 140 may be connected to specific language model plugin 130 and general purpose language model plugin 135, and memory 145. However, any variety of connections between the aforementioned components of information handling system 100 are envisioned as falling within the scope of the present disclosure. In addition, connections between components may be omitted for descriptive clarity. Further, the operations described herein as being performed by application 115 and specific language model plugin 130 and general purpose language model plugin 135 may be performed or executed by processor 140.

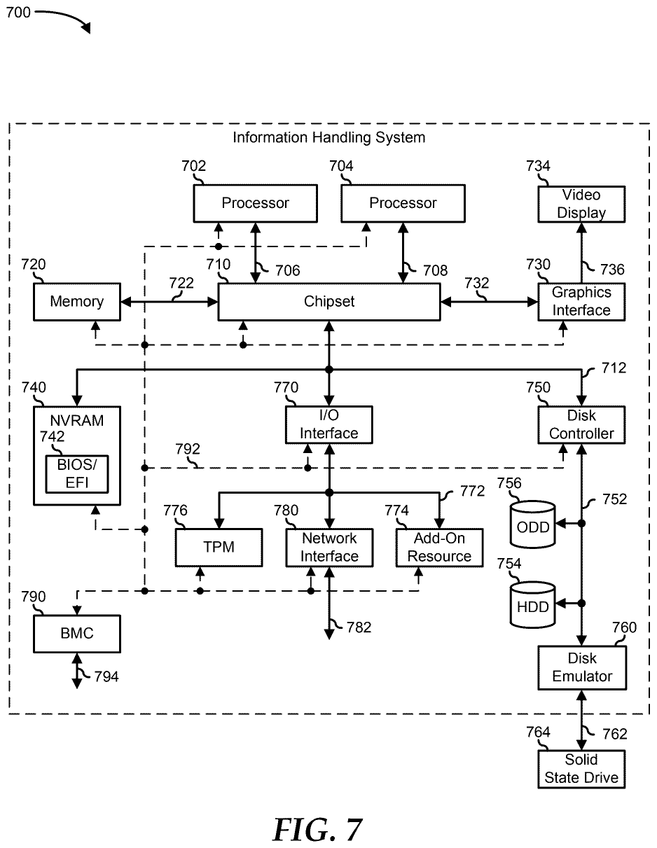

Information handling system 100, which is similar to information handling system 700 of FIG. 7, may be a personal computer, a desktop computer system, a laptop computer system, a server computer system, a mobile device, a tablet computing device, a personal digital assistant, a consumer electronic device, an electronic music player, an electronic camera, an electronic video player, a wireless access point, a network storage device, or any other suitable computing device. Information handling system 100 may also be a portable information handling system that may include a laptop, a notebook, a smartphone, a tablet, or a personal digital assistant, among others. In one embodiment, information handling system 100 may be a client device that is part of a fleet of devices owned by an enterprise.

Information handling system 100 may be configured to handle applications with AI capabilities, such as application 115. For example, application 115 may be a conversational AI application. In particular, information handling system 100 may be configured with the capability to run one or more AI models, also referred to simply as models. Although it is shown that information handling system 100 includes one processor, one of skill in the art will appreciate that information handling system 100 may include additional processing units, such as one or a combination of a graphics processing unit (GPU), NPU, or similar. The NPU may be a discrete NPU or an integrated NPU. However, information handling system 100 may include both types of NPU.

Application 115 may be any software configured to utilize AI models, such as large language models to execute its features and business logic by using language model plugins, such as specific language model plugin 130 and general purpose language model plugin 135 via language model contracts. In this example, specific language model plugin 130 supports specific language model contract 120 and general purpose language model contract 125. General purpose language model plugin 135 supports general purpose language model contract 125. Language model contracts may be configured to define how application 115 may communicate with their associated language model plugins. In addition, the language model contracts may provide information regarding the capabilities or functions of their associated AI models. As such, specific language model contract 120 may provide hints on the inputs and outputs of the AI model associated with the language model plugin.

Specific language model contract 120 may provide mechanisms or interfaces for application 115 to utilize specific language model plugin 130. In one example, specific language model plugin 130 may be a plugin for a specific AI model, such as META LLAMA 3, wherein specific language model contract 120 may be particular to specific language model plugin 130. Specific contracts are generally contracts that uniquely identify an AI model or family of AI models with more specific input/output/configuration specifications related to that AI model or family of AI models.

General purpose language model contract 125 may be a general-purpose contract that provides mechanisms or interfaces for language model plugins in general. As such, general purpose language model contract 125 may be utilized by specific language model plugin 130 and general purpose language model plugin 135. Similarly, two applications may utilize general purpose language model contract 125. Thus, one instance of a capability contract may be installed in the information handling system. General purpose contracts are generally high-level representations of use cases or capabilities backed by AI models, such as language models, audio transcription, audio translation, image segmentation, image super-resolution, image generation, etc. In this example, general purpose language model plugin 135 can be a plugin for another specific AI model, such as MISTRAL AI. Thus, general purpose language model plugin 135 may also have a corresponding specific language model contract which is not shown. Typically, an application developer may use discovery application programming interfaces (APIs) at runtime to identify the set of AI models available to support any one general-purpose contract and can pass or choose an AI model to service their request on the capability contract, also referred to as a general purpose contract.

Processor 140, which is similar to processors 702 and 704 of FIG. 7, may be configured to execute instructions of application 115 among others. As such, processor 140 has the capability to execute AI instructions. Memory 145, which is similar to a memory 720 of FIG. 7, may comprise of a non-volatile memory or similar that is accessible and capable of storing instructions to be executed by processor 140 among other information.

NPU 150 may comprise any system, device, or apparatus, such as a hardware accelerator that is designed for AI and machine learning tasks. In one example, NPUs, such as NPU 150 may be optimized to handle the complex computations required by deep learning algorithms. This optimization makes NPUs efficient at processing AI tasks, such as natural language processing, image analysis, and more. NPUs utilized by information handling system 100 may be of various types including discrete NPUs and integrated NPUs.

Modern AI applications in an enterprise environment are experiencing an increase in the complexity of delivery due to the new constraints around versioning, maintenance, and installation of the actual AI features, AI models, and other artifacts to the application. The AI models are often coupled to a specific device they must be run on. For example, if a particular AI model or model plugin is optimized to run on a processing unit, then the AI model or model plugin may be associated with a runtime provider plugin for that processing unit. Accordingly, if the AI model or model plugin is optimized to run on another processing unit, then the AI model or model plugin may be associated with a runtime provider plugin for the other processing unit.

In a traditional delivery model, this means an application should be prepared to handle installation configurations for every supported model configuration. This scenario generally exponentially increases space in development to allow for model silicon optimization, model size, model fidelity constraints, etc. As such, this also increases difficulty in the development of the application in addition to increasing the difficulty of deployment of the application.

For example, a developer is developing a local retrieval augmented generation (RAG) application for his company in order to mix public documentation available on the cloud with private documentation available on a user's local computer. His company deploys five different configurations of systems, and during development, the developer identifies two different large language models with varying degrees of accuracy across the five configurations. As such, the developer typically writes his application towards a common language model contract, enabling him to constrain the LLM model to a specific configuration based on what is available on the current device. To address these and other concerns, the present disclosure provides a system and method to decouple applications from AI models and decouple AI models from silicon-specific runtime, enabling a simplified workflow for app developers to build and deploy AI features on any given system.

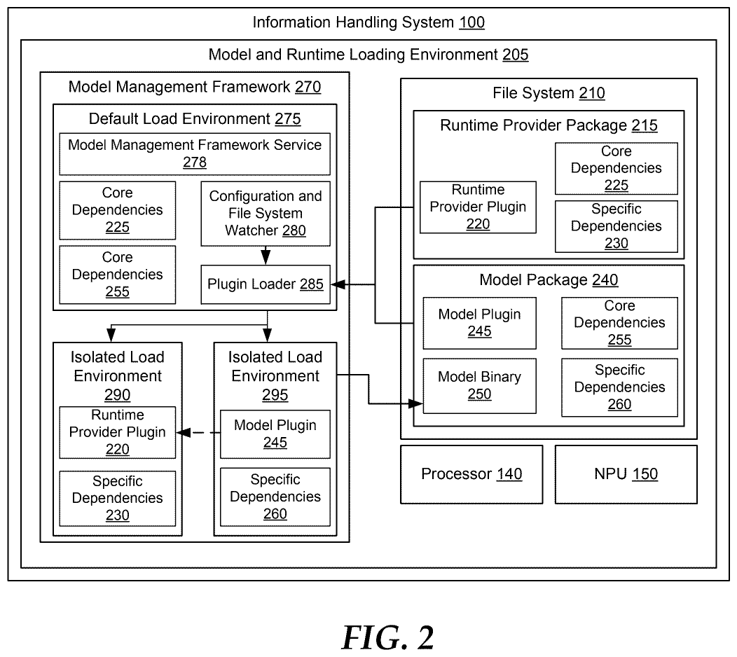

Modularized converted AI models enable dynamic deployment of the AI models by packaging the AI models with their binaries, plugins, and silicon-specific runtime dependencies while having a framework to ingest these AI models for runtime orchestration, as depicted in FIG. 2 below. This enables the deployment and usage of AI applications across a diverse ecosystem. This also allows the dynamic discovery of AI models at runtime through capability and specific contracts to enable flexible and scalable deployment while reducing complexity and ensuring compatibility, which addresses key limitations of traditional AI client model deployment by enabling modularity, adaptability, and resource efficiency.

Thus, during the development of AI applications, an application developer may write code against a capability contract. The application developer may also write code against a contract specific to a particular AI model. In addition, the application may be able to utilize more than one general-purpose contract and more than one specific contract. In this example, application 115 is written against specific language model contract 120 and general purpose language model contract 125.

FIG. 2 illustrates a portion of information handling system 100 for versioning and deployment of AI models and runtime assets in a shared environment, according to an embodiment of the present disclosure. Information handling system 100 includes processor 140, NPU 150, and a model and runtime loading environment 205, which includes a file system 210, and a model management framework (MMF) 270. File system 210 includes software packages, such as a runtime provider package 215 and a model package 240. Runtime provider package 215 includes a runtime provider plugin 220, core dependencies 225, and specific dependencies 230. Runtime provider package 215 may also include runtime provider binaries that is associated with a model binary 250 and/or a model plugin 245. Processor 140 and NPU 150 may be connected to components of file system 210 and MMF 270. However, any variety of connections between the aforementioned components of information handling system 100 are envisioned as falling within the scope of the present disclosure. In addition, connections between components may be omitted for descriptive clarity. Further, the operations described herein as being performed by application 115 and specific language model plugin 130 and general purpose language model plugin 135 may be performed or executed by processor 140.

MMF 270 includes a default load environment 275 of a default location in a memory of information handling system 100 and isolated load environments 290 and 295 in an isolated portion of the memory, such as memory 145 of FIG. 1, from each other and default load environment 275. Isolated load environment 290 may be created when runtime provider plugin 220 is loaded by plugin loader 285 into the memory. Similarly, isolated load environment 295 may be created when model plugin 245 is loaded by plugin loader 285 into the memory.

Default load environment 275 may be a location in memory where code or instructions are loaded by default at runtime in a process space. Default load environment 275 includes a configuration and file system watcher 280, and a plugin loader 285. Processor 140 and NPU 150 may be communicatively coupled to MMF 270 and file system 210. However, any variety of connections between the aforementioned components of information handling system 100 are envisioned as falling within the scope of the present disclosure. In addition, connections between components may be omitted for descriptive clarity. Further, the operations described herein as being performed by various components may be performed or executed by processor 140 and/or NPU 150.

File system 210 may be configured to manage and organize files in information handling system 100, such as files associated with runtime provider package 215 and model package 240. Runtime provider plugins may be packaged during release in an installer package, similar to runtime provider package 215. The installer package typically includes a runtime provider plugin and core and/or specific dependencies of the runtime provider plugin. In this example, runtime provider package 215 includes a runtime provider plugin 220, core dependencies 225, and specific dependencies 230. Runtime provider package 215 may include an installer, such as an .msi file or similar. Runtime provider plugin 220 may be configured to execute an AI model that is associated with model plugin 245.

AI models may be packaged during release in an installer package called an MMF converted model (MCM), such as model package 240. The MMF and MCM may be configured to facilitate the consumption of AI device-enabled AI capabilities within line of business applications. As such, the installer package typically includes a model plugin, model binaries or artifacts, and core and/or specific dependencies of the model. In this example, model package 240 includes model plugin 245, model binary 250, core dependencies 255, and specific dependencies 260. Model plugin 245 may be similar to specific language model plugin 130 and/or general purpose language model plugin 135 of FIG. 1. Model package 240 may also include an MCM installer. Model binary 250 may include code or instructions that represent the AI model which can be executed via model plugin 245.

The core dependencies are generally loaded in the main process or default load environment at runtime and used to communicate between core code modules and plugin modules. In this example, core dependencies 225 and 255 may be loaded in default load environment 275. Specific dependencies that may be needed by a plugin to run, stay with the plugin code module. In this example, specific dependencies 230 may be needed by runtime provider plugin 220. As such, specific dependencies 230 is with runtime provider plugin 220 at isolated load environment 290. Specific dependencies 260 may be needed by model plugin 245 and/or model binary 250 to run. As such, specific dependencies 260 is with model plugin 245 at isolated load environment 295. The MCM can also include a configuration module that includes additional information for the runtime provider that a model may require. For example, the configuration module may include runtime provider setup logic and configuration properties of an NPU for an AI model optimized to run on the NPU.

MMF 270 may be configured to include technologies that help the enterprise manage AI models. MMF core components which include an MMF service, a configuration and file system watcher 280, and a plugin loader 285 may be deployed and installed in information handling system 100. During installation, various settings and/or properties may be configured. For example, install flags, registry keys, and file system paths, such as in protected locations, among others may be configured. The file system paths may be located in protected locations to apply security best practices. MMF service 278 may be a core component of MMF 270 and is a background service that is configured to load a specific model plugin and runtime provider plugin along with their dependencies at their appropriate environment for AI model execution via plugin loader 285.

When an MCM is deployed an MCM installer may follow an installation flow that performs various checks and establishes that the model can be run on the current system. For example, the installation flow may perform a hardware and/or platform check, such as to determine whether processor 140 and/or NPU 150 may be configured to run the AI model associated with model binary 250 via model plugin 245. The installation flow may also establish the presence of dependencies and that any end-user license agreement (EULA) for the AI model has already been accepted. For example, an installer associated with model package 240 may determine whether core and specific dependencies of model plugin 245 are present in information handling system 100.

If the various checks are successful, then the MCM installer may extract information associated with a specific runtime provider. The MCM installer may also check if the specific runtime provider already exists. For example, the installer may check whether the runtime provider's globally unique identifier (GUID) is in the registry. In this particular example, the MCM installer may check if a GUID is associated with runtime provider plugin 220 via configuration and file system watcher 280. If the runtime provider already exists, a reference counter for that runtime provider may be incremented. The reference counter may be located in the registry, a configuration file, or another secure location. If the runtime provider does not exist, the runtime provider may be added to the system along with its dependencies, and the reference counter is set to one. For example, the runtime provider may be downloaded from an endpoint management service that manages and/or controls information handling system 100.

In addition to adding the runtime provider, the runtime provider plugin and its dependencies may be added to the file system. Next, the MCM installer may extract and validate the AI model and/or AI model plugin, such as model plugin 245 according to a specification. After a successful validation, the AI mode and/or AI model plugin may then be laid down to the file system. In addition, one or more settings may be configured. For example, a new registry entry pointing at a model file path may be entered.

Because the specific dependencies include code or instructions that are particular to its associated model plugins and/or runtime provider plugins, the specific dependencies may be loaded into the isolated load context at runtime with their associated plugins. For example, the model plugin may use a library to create web requests, wherein the contents of the library may not be needed by core components of MMF 270. In this example, runtime provider plugin 220 may be loaded in isolated load environment 290 of memory along with specific dependencies 230. Similarly, model plugin 245 may be loaded in isolated load environment 295 of the memory along with specific dependencies 260. If there is a second model plugin or a second runtime provider plugin, then another isolated load environment may be created.

Core dependencies 225 and 255 may be any suitable interface that runtime provider plugin 220, model plugin 245, and model binary 250 may use respectively to communicate into and out of the isolated load environment. For example, runtime provider plugin 220 may use core dependencies 225 to communicate in and out of isolated load environment 290. In another example, model plugin 245 may use core dependencies 255 to communicate in and out of isolate load environment 295. This may allow more than one version of the same model plugin or runtime provider plugin to be loaded as long as the versions have different GUIDs at installation.

Configuration and file system watcher 280 may be any suitable system, apparatus, or device operable to check the configuration of information handling system 100 and its file system 210 to detect new runtime provider plugins and/or model plugins to load. The new plugins are discrete units of functionality or code in a binary format, such as a dynamic link library format. For example, configuration and file system watcher 280 can check specific keys in a registry, configuration file, or similar. Configuration and file system watcher 280 can also check specific folders and locations in file system 210.

Plugin loader 285 may be any suitable system, apparatus, or device operable to receive a file path associated with the plugins and load them in memory. For example, plugin loader 285 may be configured to load runtime provider plugin 220 in isolated load environment 290 and isolated load environment 295. Isolated load environment 290, isolated load environment 295, and default load environment 275 may be discrete locations in a memory of information handling system 100.

Because the model plugins are modularized, this enables dynamic deployment of AI models by packaging the AI models with their binaries, plugins, and silicon-specific runtime dependencies while having the MMF framework ingest these AI models for runtime orchestration. This decouples applications from specific models and silicon runtimes enabling the deployment and usage of AI across a diverse ecosystem. This also allows the dynamic discovery of AI models at runtime through capability contracts to enable flexible and scalable deployment while reducing complexity and ensuring compatibility. As such, the application may be able to utilize the capabilities of both contracts because of the modularization and isolation of the model plugins and runtime provider plugins. Accordingly, this addresses the key limitations of traditional AI client model deployment by enabling modularity, adaptability, and resource efficiency.

Those of ordinary skill in the art will appreciate that the configuration, hardware, and/or software components of information handling system 100 depicted in FIG. 1 may vary. For example, the illustrative components within information handling system 100 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

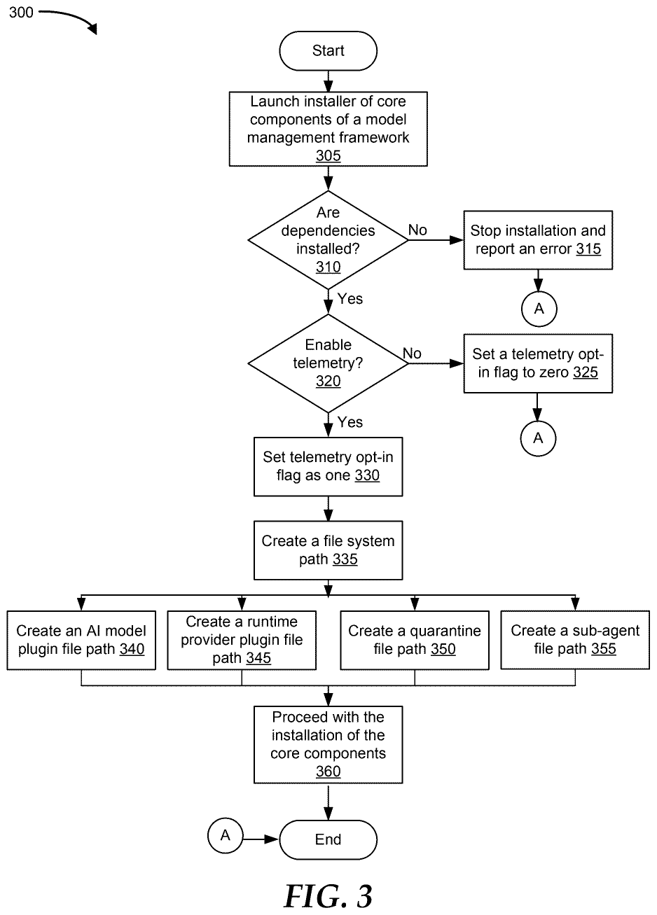

FIG. 3 illustrates a portion of a flowchart of a method 300 for installation of core components of an MMF, according to an embodiment of the present disclosure. Method 300 may be performed by any suitable component of information handling system 100 including but not limited to components associated with application 115, specific language model plugin 130 and general purpose language model plugin 135, model and runtime loading environment 205 of FIGS. 1 and 2. While embodiments of the present disclosure are described in terms of the components of information handling system 100 of FIGS. 1 and 2, it should be recognized that other components may be utilized to perform the described method. One of skill in the art will appreciate that this flow chart explains a typical example, which can be extended to applications or services in practice. It will be readily appreciated that not every operation set forth in this flow chart is always necessary and that certain operations may be combined, performed simultaneously, in a different order, or perhaps omitted, without varying from the scope of the disclosure.

Method 300 typically starts at a block 305 where an installer of core components of an MMF may be launched at an information handling system by a user, such as an administrator. The core components of the MMF may include an MMF service, a configuration and file system watcher, and a plugin loader. In one example, the installer may be an automation script, such as a power shell script, an .msi file, or similar, that handles the installation of a software package that includes the core components of the MMF, such as MMF service, configuration, and file system watcher, and plugin loader 285.

At a decision block 310, the installer may determine whether one or more dependencies of the core components are installed. If one or more dependencies are not installed, then the “NO” branch is taken, and the method proceeds to a block 315. If one or more dependencies of the core components are installed, then the “YES” branch is taken, and the method proceeds to a decision block 320.

At block 315, the installer may stop the current installation and report an error. The installer may also update configuration data and log information associated with the current installation. In addition, the installer may set a flag or registry key to indicate that the installation was not successful. For example, the installer may set the flag to zero to indicate that the installation was not successful. In another example, the installer may set the registry key to a particular value to indicate the status of the installation.

At decision block 320, the installer may determine whether to enable telemetry associated with the installation. In one example, telemetry data collection is enabled by default. In another example, the administrator may choose whether to opt out of the telemetry data collection. This data may be set in a manifest utilized for the installation. If the telemetry data collection is to be disabled, then the “NO” branch is taken, and the method proceeds to a block 325. If the telemetry data collection is to be enabled, then the “YES” branch is taken, and the method proceeds to a block 330. When the telemetry data collection is enabled, data associated with the installation may be collected, logged, and/or stored at a secure location that is accessible to the user for analysis.

At block 325, the installer may set a telemetry flag or a registry key to zero. At block 330, the installer may set the telemetry flag or the registry key to one. The method may proceed to a block 335, where the installer may create a file system path for the MMF service. For example, the installer may create a root at a directory structure or file system for the MMF service. The method may proceed to blocks 340, 345, 350, and 355, wherein the installer may create several branches of the directory structure or filesystem. Blocks 340, 345, 350, and 355 may be executed in parallel.

At block 340, the installer may create an AI model plugin file path. For example, the installer may create a branch or folder in the directory structure or filesystem that would be used to store one or more AI model plugins. The AI model plugin file path may be created from the root of the data structure or filesystem. At block 345, the installer may create a runtime provider file path. For example, the installer may create a branch or folder in the directory structure or filesystem that would be used to store one or more runtime provider plugins. The runtime provider file path may be created from the root. At block 350, the installer may create a quarantine file path. For example, the installer may create a branch or folder in the directory structure or file system that would be used to store quarantined plugins. The quarantine file path may be created from the root of the directory structure or file system.

At block 355, the installer may create a sub-agent file path. For example, the installer may create a branch at the directory structure or filesystem tree that would be used to store sub-agents of the MMF service plugins. The sub-agent file path may be created from the root. The sub-agent may be a background service that monitors functions associated with the MMF. Subsequent to creating the branches or folders, the installer may proceed with the installation of the core components of the MMF at a block 360. In one example, the installer may store root components, or root modules of the MMF service may be stored in the root. During the installation, the installer may store modules to their appropriate file path. For example, AI model plugins may be stored in an AI model file path. After a successful installation, a registry key, flag, or similar may be set to indicate the status of the installation. For example, the flag may be set to one to indicate a successful installation. In another example, the installer may set the registry key to the AI model file path. Afterwards, the method ends.

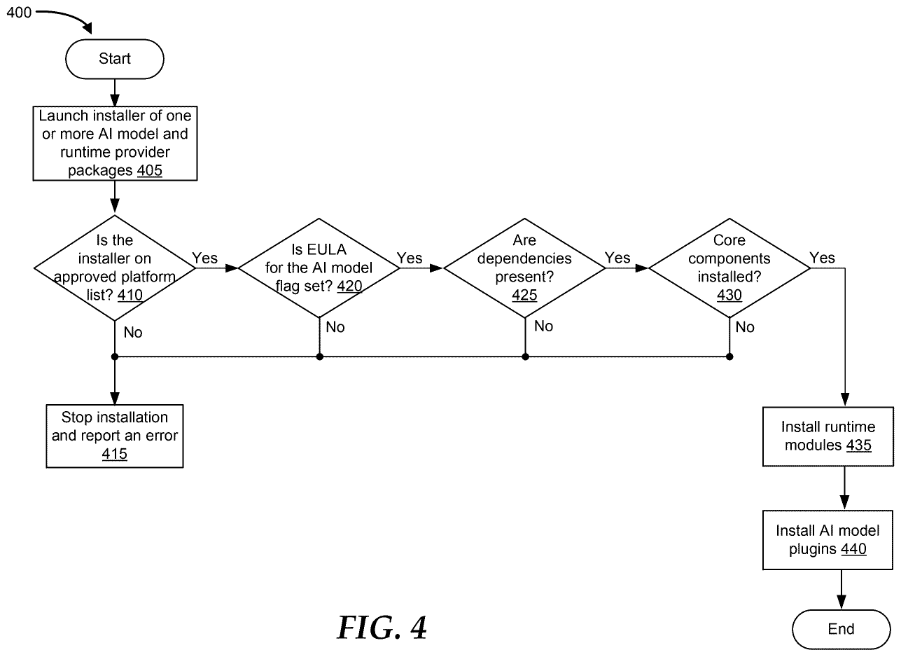

FIG. 4 illustrates a portion of a flowchart of a method 400 for installation of AI models and runtime components of an MMF service, according to an embodiment of the present disclosure. Method 400 may be performed by any suitable component of information handling system 100 including but not limited to components associated with application 115, specific language model plugin 130 and general purpose language model plugin 135, model and runtime loading environment 205 of FIGS. 1 and 2. While embodiments of the present disclosure are described in terms of the components of information handling system 100 of FIGS. 1 and 2, it should be recognized that other components may be utilized to perform the described method. One of skill in the art will appreciate that this flow chart explains a typical example, which can be extended to applications or services in practice. It will be readily appreciated that not every operation set forth in this flow chart is always necessary and that certain operations may be combined, performed simultaneously, in a different order, or perhaps omitted, without varying from the scope of the disclosure.

Method 400 typically starts at a block 405 where an installer of AI model and runtime provider packages for the management service may be launched by a user, such as an administrator. In another embodiment, the installer may be launched subsequent to a successful installation of the MMF service. In one example, the installer may be an automation script, such as a power shell script, an .msi file, or similar, that handles the installation of software packages that include the AI models and runtime provider of the MMF service. Prior to proceeding with the installation, the installation process may pass several checks, as depicted in decision blocks 410, 420, 425, and 430. The checks may be performed by the installer.

At decision block 410, the method may determine whether the installer is on an approved platform list. If the installer is not on the approved platform list, then the “NO” branch is taken, and the method may proceed to block 415. If the installer is on the approved platform list, then the “YES” branch is taken, and the method may proceed to decision block 420. At block 415, the method may stop the current installation and report an error. The method may also log information associated with the current installation.

At decision block 420, the method may determine if an end user license agreement (EULA) for the AI models to be installed is assented to or enabled by checking whether an associated flag is set. If the flag is not set, then the “NO” branch is taken, and the method may proceed to block 415. If the flag is set, then the “YES” branch is taken, and the method may proceed to decision block 425.

At decision block 425, the method may determine whether one or more dependencies of the AI models and runtime providers are present or installed in the information handling system. For example, the method may parse a manifest included in a software package of the AI models and runtime providers for the dependencies. The method may then determine whether these dependencies are present or installed in the information handling system, such as by checking registry keys, system configuration, properties of installed software applications, plugins, etc. Other methods of checking for dependencies may also be performed. If the dependencies are not present or installed, then the “NO” branch is taken, and the method may proceed to block 415. If the dependencies are present or installed, then the “YES” branch is taken, and the method may proceed to decision block 430.

At decision block 430, the method may determine whether the core components of the MMF are installed in the information handling system. In one embodiment, the method may check whether a registry key value and/or whether a file path associated with the core components of the MMF service is present. For example, if an expected registry key value is present and an expected file path is present, then the core components of the MMF service may have been installed. If the core components of the MMF service are not installed, then the “NO” branch is taken, and the method may proceed to block 415. If the core components of the MMF service are installed, then the “YES” branch is taken, and the method may proceed to a block 435. At block 435, the method may launch an installer of a runtime provider package. Subsequently, the method may proceed to a block 440, where the method may launch an MCM installer of a model package. Afterwards, the method ends.

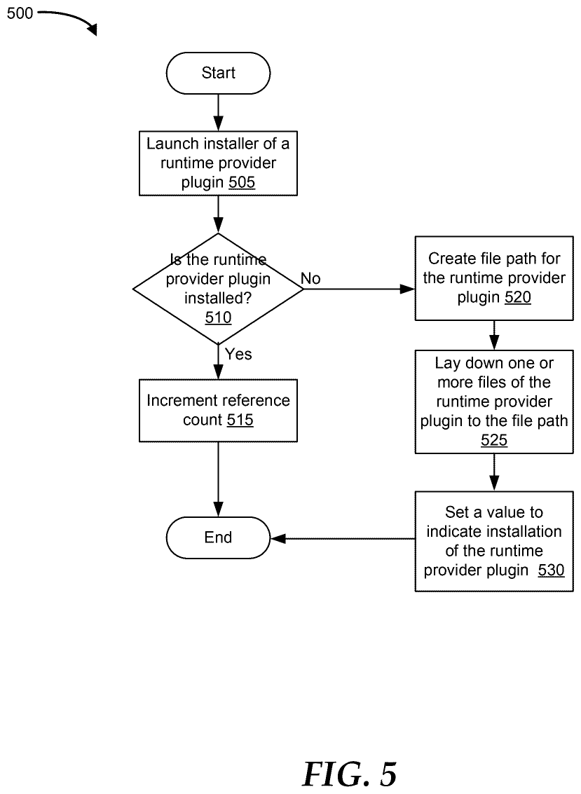

FIG. 5 illustrates a portion of a flowchart of a method 500 for the installation of a runtime provider assets, according to an embodiment of the present disclosure. The runtime provider assets may be installed using a runtime provider package may can include a runtime provider, a runtime provider plugin, and its dependencies. In particular, method 500 may represent a detailed illustration of block 435 of FIG. 4. Method 500 typically starts at a block 505 where an installer of the runtime provider package that includes a runtime provider plugin and its dependencies may be launched at an information handling system by a user, such as an administrator. In one example, the installer may be an automation script, such as a power shell script, an .msi file, or similar, that handles the installation of the runtime provider package.

At a decision block 510, the installer may determine whether a current runtime provider or runtime provider plugin being processed is present in the information handling system. In one embodiment, the method may check for a registry key value and/or whether a file path associated with the current runtime provider or runtime provider plugin is present. For example, if an expected registry key value is present and an expected file path is present, then the current runtime provider or runtime provider plugin may have been already installed. If the current runtime provider or runtime provider plugin is installed, then the “YES” branch is taken, and the method may proceed to a block 515. If the current runtime provider or runtime provider plugin is not installed, then the “NO” branch is taken, and the method may proceed to a block 520.

At block 515, the installer may increment a reference counter. The reference counter may be used to keep track of whether a particular runtime provider plugin is already installed. In another embodiment, an install flag may be used instead of the reference counter. Because the runtime provider or runtime provider plugin is already installed, the installer may not proceed with the current installation. Information associated with the status of the installation may be logged. Afterwards, the method ends.

At block 520, the installer may create a runtime provider or runtime provider plugin file path. For example, the installer may create a branch or folder in the directory structure or filesystem that would be used to store one or more runtime provider plugins. The method may proceed to a block 525, where the installer may extract one or more files associated with the runtime provider plugin and associated dependencies, which the method may then store the one or more files according to the file path. The method may proceed to a block 530 where the installer may set a value to indicate the installation of the runtime provider plugin. For example, the installer may set a flag to one or true. In another example, the installer may set a value of a registry key to the file path of the runtime provider or runtime provider plugin. Afterwards, the method ends.

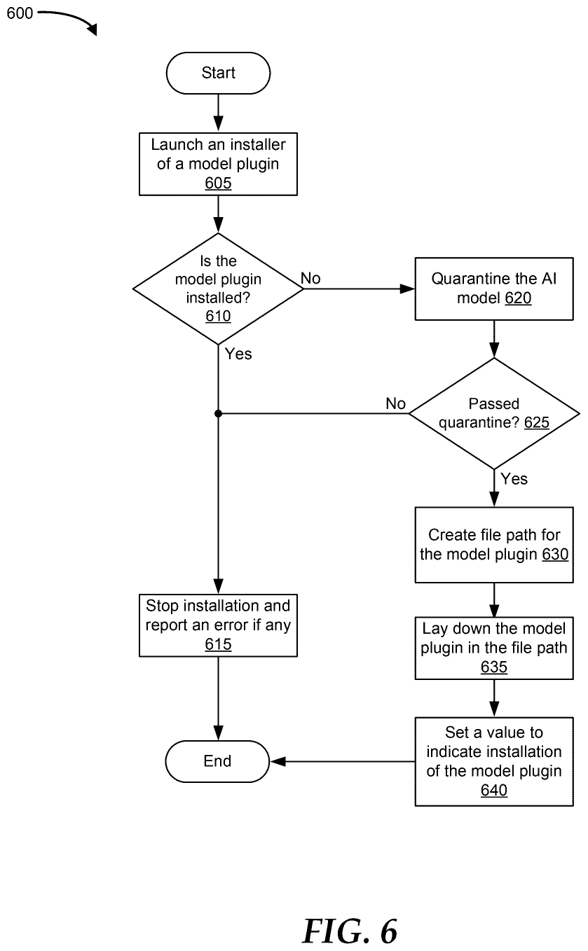

FIG. 6 illustrates a portion of a flowchart of a method 600 for an installation of an AI model, according to an embodiment of the present disclosure. A model package may include the AI model, a model plugin associated with the AI model and its dependencies. In particular, method 600 may represent a detailed illustration of block 440 of FIG. 4. Method 600 typically starts at a block 605 where an installer of the model package, also referred to as an MCM installer, may be launched by a user, such as an administrator. In one example, the installer may be an automation script, such as a power shell script, an .msi file, or similar, that handles the installation of the model package.

The method may proceed to a decision block 610 where the installer may determine whether a current AI model or model plugin being processed is installed in the information handling system. In one embodiment, the method may check for a registry key value and/or whether a file path associated with the current model plugin is present. For example, if an expected registry key value is present and an expected file path is present, then the current AI model or model plugin may have been already installed. If the current AI model or model plugin is installed, then the “YES” branch is taken, and the method may proceed to a block 615. If the current AI model or model plugin is not installed, then the “NO” branch is taken, and the method may proceed to a block 620.

At block 615, the installer may stop the installation process and report an error if any. Afterwards, the method fails. At block 620, the installer may quarantine the AI model and/or the model plugin. For example, the method may store the AI model and/or model plugin in the quarantine file path that was created in FIG. 3. The quarantine may be utilized as a sandbox to perform one or more security checks against the AI model and/or model plugin. This is to validate and/or verify the capabilities and security of the AI model and/or model plugin. The method may also perform various checks and establish that the AI model and/or model plugin can be run or executed on the information handling system. For example, the method may determine that the information handling system includes a processing unit that the AI model and/or model plugin was optimized for. The method may proceed to a decision block 625 to determine whether the AI model and/or model plugin passed quarantine. If the AI model and/or model plugin fails the quarantine, then the “NO” branch is taken, and the method may proceed to block 615. If the AI model and/or model plugin passes the quarantine, then the “YES” branch is taken, and the method may proceed to a block 630.

At block 630, the installer may create a file path for the AI model and/or model plugin. For example, the installer may create a branch or folder in the directory structure or file system that was created in FIG. 3. At a block 635, the installer may store or lay down the AI model, model plugin, and its dependencies in the file path. The method may proceed to a block 640, where the installer may set a value to indicate the installation of the AI model and/or model plugin. For example, the installer may set a flag to one or true. In another example, the installer may set a value of a registry key to the file path of the model plugin. Afterwards, the method ends.

FIG. 7 illustrates an embodiment of an information handling system 700 including processors 702 and 704, a chipset 710, memory 720, a graphics adapter 730 connected to a video display 734, a non-volatile RAM (NVRAM) 740 that includes a basic input and output system/extensible firmware interface (BIOS/EFI) module 742, a disk controller 750, a hard disk drive (HDD) 754, an optical disk drive 756, a disk emulator 760 connected to a solid-state drive (SSD) 764, an input/output (I/O) interface 770 connected to an add-on resource 774 and a trusted platform module (TPM) 776, a network interface 780, and a baseboard management controller (BMC) 790. Processor 702 is connected to chipset 710 via processor interface 706, and processor 704 is connected to the chipset via processor interface 708. In a particular embodiment, processors 702 and 704 are connected together via a high-capacity coherent fabric, such as a HyperTransport link, a QuickPath Interconnect, or the like. Chipset 710 represents an integrated circuit or group of integrated circuits that manage the data flow between processors 702 and 704 and the other elements of information handling system 700. In a particular embodiment, chipset 710 represents a pair of integrated circuits, such as a northbridge component and a southbridge component. In another embodiment, some or all of the functions and features of chipset 710 are integrated with one or more of processors 702 and 704.

Memory 720 is connected to chipset 710 via a memory interface 722. An example of memory interface 722 includes a Double Data Rate (DDR) memory channel and memory 720 represents one or more DDR Dual In-Line Memory Modules (DIMMs). In a particular embodiment, memory interface 722 represents two or more DDR channels. In another embodiment, one or more of processors 702 and 704 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 720 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 730 is connected to chipset 710 via a graphics interface 732 and provides a video display output 736 to a video display 734. An example of a graphics interface 732 includes a Peripheral Component Interconnect-Express (PCIe) interface and graphics adapter 730 can include a four-lane (x4) PCIe adapter, an eight-lane (x8) PCIe adapter, a 16-lane (x16) PCIe adapter, or another configuration, as needed or desired. In a particular embodiment, graphics adapter 730 is provided down on a system printed circuit board (PCB). Video display output 736 can include a DVI, a HDMI, a DisplayPort interface, or the like, and video display 734 can include a monitor, a smart television, an embedded display such as a laptop computer display, or the like.

NVRAM 740, disk controller 750, and I/O interface 770 are connected to chipset 710 via an I/O channel 712. An example of I/O channel 712 includes one or more point-to-point PCIe links between chipset 710 and each of NVRAM 740, disk controller 750, and I/O interface 770. Chipset 710 can also include one or more other I/O interfaces, including a PCIe interface, an Industry Standard Architecture (ISA) interface, a Small Computer Serial Interface (SCSI) interface, an I²C interface, a System Packet Interface, a Universal Serial Bus (USB), another interface, or a combination thereof. NVRAM 740 includes BIOS/EFI module 742 that stores machine-executable code (BIOS/EFI code) that operates to detect the resources of information handling system 700, to provide drivers for the resources, to initialize the resources, and to provide common access mechanisms for the resources. The functions and features of BIOS/EFI module 742 will be further described below.

Disk controller 750 includes a disk interface 752 that connects the disc controller to a hard disk drive (HDD) 754, to an optical disk drive (ODD) 756, and to disk emulator 760. An example of disk interface 752 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 760 permits SSD 764 to be connected to information handling system 700 via an external interface 762. An example of external interface 762 includes a USB interface, an institute of electrical and electronics engineers (IEEE) 1394 (Firewire) interface, a proprietary interface, or a combination thereof. Alternatively, SSD 764 can be disposed within information handling system 700.

I/O interface 770 includes a peripheral interface 772 that connects the I/O interface to add-on resource 774, to TPM 776, and to network interface 780. Peripheral interface 772 can be the same type of interface as I/O channel 712 or can be a different type of interface. As such, I/O interface 770 extends the capacity of I/O channel 712 when peripheral interface 772 and the I/O channel are of the same type, and the I/O interface translates information from a format suitable to the I/O channel to a format suitable to the peripheral interface 772 when they are of a different type. Add-on resource 774 can include a data storage system, an additional graphics interface, a network interface card (NIC), a sound/video processing card, another add-on resource, or a combination thereof. Add-on resource 774 can be on a main circuit board, on separate circuit board, or add-in card disposed within information handling system 700, a device that is external to the information handling system, or a combination thereof.

Network interface 780 represents a network communication device disposed within information handling system 700, on a main circuit board of the information handling system, integrated onto another component such as chipset 710, in another suitable location, or a combination thereof. Network interface 780 includes a network channel 782 that provides an interface to devices that are external to information handling system 700. In a particular embodiment, network channel 782 is of a different type than peripheral interface 772 and network interface 780 translates information from a format suitable to the peripheral channel to a format suitable to external devices.

In a particular embodiment, network interface 780 includes a NIC or host bus adapter (HBA), and an example of network channel 782 includes an InfiniBand channel, a Fibre Channel, a Gigabit Ethernet channel, a proprietary channel architecture, or a combination thereof. In another embodiment, network interface 780 includes a wireless communication interface, and network channel 782 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 782 can be connected to an external network resource (not illustrated). The network resource can include another information handling system, a data storage system, another network, a grid management system, another suitable resource, or a combination thereof.

BMC 790 is connected to multiple elements of information handling system 700 via one or more management interface 792 to provide out-of-band monitoring, maintenance, and control of the elements of the information handling system. As such, BMC 790 represents a processing device different from processor 702 and processor 704, which provides various management functions for information handling system 700. For example, BMC 790 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 790 can vary considerably based on the type of information handling system. BMC 790 can operate in accordance with an Intelligent Platform Management Interface (IPMI). Examples of BMC 790 include an Integrated Dell® Remote Access Controller (iDRAC).

Management interface 792 represents one or more out-of-band communication interfaces between BMC 790 and the elements of information handling system 700 and can include an Inter-Integrated Circuit (I²C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 700, that is apart from the execution of code by processors 702 and 704 and procedures that are implemented on the information handling system in response to the executed code.

BMC 790 operates to monitor and maintain system firmware, such as code stored in BIOS/EFI module 742, option ROMs for graphics adapter 730, disk controller 750, add-on resource 774, network interface 780, or other elements of information handling system 700, as needed or desired. In particular, BMC 790 includes a network interface 794 that can be connected to a remote management system to receive firmware updates, as needed or desired. Here, BMC 790 receives the firmware updates, stores the updates to a data storage device associated with the BMC, and transfers the firmware updates to NVRAM of the device or system that is the subject of the firmware update, thereby replacing the currently operating firmware associated with the device or system, and reboots information handling system, whereupon the device or system utilizes the updated firmware image.

BMC 790 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 790, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 790 is included on a main circuit board (such as a baseboard, a motherboard, or any combination thereof) of information handling system 700 or is integrated onto another element of the information handling system such as chipset 710, or another suitable element, as needed or desired. As such, BMC 790 can be part of an integrated circuit or a chipset within information handling system 700. An example of BMC 790 includes an iDRAC, or the like. BMC 790 may operate on a separate power plane from other resources in information handling system 700. Thus BMC 790 can communicate with the management system via network interface 794 while the resources of information handling system 700 are powered off. Here, information can be sent from the management system to BMC 790 and the information can be stored in a RAM or NVRAM associated with the BMC. Information stored in the RAM may be lost after power-down of the power plane for BMC 790, while information stored in the NVRAM may be saved through a power-down/power-up cycle of the power plane for the BMC.

Information handling system 700 can include additional components and additional busses, not shown for clarity. For example, information handling system 700 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 700 can include multiple central processing units (CPUs) and redundant bus controllers. One or more components can be integrated together. Information handling system 700 can include additional buses and bus protocols, for example, I²C and the like. Additional components of information handling system 700 can include one or more storage devices that can store machine-executable code, one or more communications ports for communicating with external devices, and various input and output (I/O) devices, such as a keyboard, a mouse, and a video display.

For purposes of this disclosure, information handling system 700 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 700 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 700 can include processing resources for executing machine-executable code, such as processor 702, a programmable logic array (PLA), an embedded device such as a System-on-a-Chip (SoC), or other control logic hardware. Information handling system 700 can also include one or more computer-readable media for storing machine-executable code, such as software or data.

The term “user” in this context should be understood to encompass, by way of example and without limitation, a user device, a person utilizing or otherwise associated with the device, or a combination of both. An operation described herein as being performed by a user may therefore be performed by a user device, or by a combination of both the person and the device.

Although FIGS. 3, 4, 5, and 6 show example blocks of methods 300, 400, 500, and 600 in some implementations, methods 300, 400, 500, and 600 may include additional blocks, fewer blocks, different blocks, or differently arranged blocks than those depicted in FIGS. 3, 4, 5, and 6. Those skilled in the art will understand that the principles presented herein may be implemented in any suitably arranged processing system. Additionally, or alternatively, two or more of the blocks of methods 300, 400, 500, and 600 may be performed in parallel. For example, blocks 330 and 335 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
launching, by a processor of an information handling system, an installer of a software package in the information handling system, wherein the software package includes an artificial intelligence model and a dependency;
determining whether the artificial intelligence model can be executed on the information handling system;
in response to determining that the artificial intelligence model can be executed on the information handling system, installing the artificial intelligence model; and
loading, by the processor, an artificial intelligence model plugin and the dependency in an isolated load environment at runtime, wherein the artificial intelligence model plugin is associated with the artificial intelligence model.

2. The method of claim 1, further comprising: installing core components of a model management framework.

3. The method of claim 1, wherein the dependency is specific to the artificial intelligence model plugin.

4. The method of claim 1, wherein the software package further includes a core dependency.

5. The method of claim 4, further comprising: loading the core dependency to a default load environment.

6. The method of claim 4, wherein the core dependency is utilized by the artificial intelligence model plugin in communication into and out of the isolated load environment.

7. The method of claim 1, further comprising: installing a runtime provider plugin associated with the artificial intelligence model.

8. The method of claim 7, further comprising: loading the runtime provider plugin in another isolated load environment.

9. An information handling system, comprising:
a processor; and
a memory coupled to the processor, the memory having program instructions stored thereon that upon execution cause the processor to:
launch an installer of a software package at the information handling system, wherein the software package includes an artificial intelligence model and a dependency;
determine whether the artificial intelligence model can be executed on the information handling system;
in response to a determination that the artificial intelligence model can be executed on the information handling system, install the artificial intelligence model; and
load an artificial intelligence model plugin and the dependency in an isolated load environment at runtime, wherein the artificial intelligence model plugin is associated with the artificial intelligence model.

10. The information handling system of claim 9, wherein the processor is further configured to: install core components of a model management framework.

11. The information handling system of claim 9, wherein the dependency is specific to the artificial intelligence model.

12. The information handling system of claim 9, wherein the software package further includes a core dependency.

13. The information handling system of claim 12, wherein the processor is further configured to: load the core dependency to a default load environment.

14. A non-transitory computer-readable medium to store instructions that are executable to perform operations comprising:
launching an installer of a software package at an information handling system, wherein the software package includes an artificial intelligence model and a dependency;
determining whether the artificial intelligence model can be executed on the information handling system;
in response to determining that the artificial intelligence model can be executed on the information handling system, installing the artificial intelligence model; and
loading an artificial intelligence model plugin and the dependency in an isolated load environment at runtime, wherein the artificial intelligence model plugin is associated with the artificial intelligence model.

15. The non-transitory computer-readable medium of claim 14, wherein the operations further comprise: installing core components of a model management framework.

16. The non-transitory computer-readable medium of claim 14, wherein the dependency is specific to the artificial intelligence model plugin.

17. The non-transitory computer-readable medium of claim 14, wherein the software package further includes a core dependency.

18. The non-transitory computer-readable medium of claim 17, wherein the operations further comprise: loading the core dependency to a default load environment.

19. The non-transitory computer-readable medium of claim 14, wherein the core dependency is utilized by the artificial intelligence model plugin in communication into and out of the isolated load environment.

20. The non-transitory computer-readable medium of claim 14, wherein the operations further comprise: installing a runtime provider plugin associated with the artificial intelligence model plugin.
